(19) United States
(12) Patent Application Publication
(10) Pub. No.: US 2025/0321869 A1
(43) Pub. Date: Oct. 16, 2025

(54) AUTOMATED CONTAINER ORCHESTRATION PLATFORM TESTING

(71) Applicant: Capital One Services, LLC, McLean, VA (US)

(72) Inventor: Christian BARTRAM, Orlando, FL (US)

(21) Appl. No.: 18/635,600

(22) Filed: Apr. 15, 2024

(51) Int. Cl. G06F 11/36

(52) U.S. Cl. CPC G06F 11/3688; G06F 11/3644

(57) ABSTRACT

In some implementations, a device may obtain, via a notebook repository, one or more training notebooks that are associated with respective pipeline types of the container orchestration platform. The device may extract, from the one or more training notebooks, one or more executable code elements, to obtain one or more sets of executable code for respective training notebooks of the one or more training notebooks. The device may insert testing information into respective sets of executable code of the one or more sets of executable code to generate one or more test pipelines. The device may perform, via the container orchestration platform, one or more cluster tests using respective test pipelines from the one or more test pipelines. The device may provide, for display, result information indicating results of the one or more cluster tests.

### BACKGROUND

Container orchestration platforms may enable the deployment and management of containerized applications at scale. A container orchestration platform may automate the deployment, scaling, and/or operation, among other examples, of application containers across clusters of hosts, thereby abstracting away infrastructure complexities. Testing within container orchestration environments may include unit testing, integration testing, and/or end-to-end testing to ensure the reliability and resilience of applications. Testing may ensure the robustness of containerized applications within orchestrated environments.

### SUMMARY

Some implementations described herein relate to a system for automated cluster testing for a container orchestration platform. The system may include one or more memories and one or more processors communicatively coupled to the one or more memories. The one or more processors may be configured to obtain, via a notebook repository, one or more training notebooks that are associated with respective pipeline types of the container orchestration platform, wherein the one or more training notebooks are interactive computational documents that include executable code and plain-text-formatted information. The one or more processors may be configured to extract, from the one or more training notebooks, one or more executable code elements, to obtain one or more sets of executable code for respective training notebooks of the one or more training notebooks. The one or more processors may be configured to insert testing information into respective sets of executable code of the one or more sets of executable code to generate one or more test pipelines. The one or more processors may be configured to perform, via a machine learning operation system of the container orchestration platform, one or more cluster tests using respective test pipelines from the one or more test pipelines. The one or more processors may be configured to provide, for display, result information indicating results of the one or more cluster tests.

Some implementations described herein relate to a method for cluster testing for a container orchestration platform. The method may include obtaining, by a device and via a notebook repository, one or more training notebooks that are associated with respective pipeline types of the container orchestration platform. The method may include extracting, by the device and from the one or more training notebooks, one or more executable code elements, to obtain one or more sets of executable code for respective training notebooks of the one or more training notebooks. The method may include inserting, by the device, testing information into respective sets of executable code of the one or more sets of executable code to generate one or more test pipelines. The method may include performing, by the device and via the container orchestration platform, one or more cluster tests using respective test pipelines from the one or more test pipelines. The method may include providing, by the device and for display, result information indicating results of the one or more cluster tests.

Some implementations described herein relate to a non-transitory computer-readable medium that stores a set of instructions. The set of instructions, when executed by one or more processors of a device, may cause the device to provide, for display, one or more training notebooks that are associated with respective pipeline types of a container orchestration platform. The set of instructions, when executed by one or more processors of the device, may cause the device to execute, via the container orchestration platform, one or more cluster tests using respective test pipelines from one or more test pipelines, wherein the one or more test pipelines are generated via executable code included in the one or more training notebooks. The set of instructions, when executed by one or more processors of the device, may cause the device to provide, for display, result information indicating results of the one or more cluster tests.

### BRIEF DESCRIPTION OF THE DRAWINGS

FIGS. 1A-1D are diagrams of an example associated with automated container orchestration platform testing, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with automated container orchestration platform testing, in accordance with some embodiments of the present disclosure.

FIG. 4 is a flowchart of an example process associated with automated container orchestration platform testing, in accordance with some embodiments of the present disclosure.

### DETAILED DESCRIPTION

The following detailed description of example implementations refers to the accompanying drawings. The same reference numbers in different drawings may identify the same or similar elements.

In some examples, a container orchestration platform may enable automation and/or management of containerized applications. A container may be a unit of software (e.g., a software package) that includes software code and related dependencies to execute an application (e.g., code, runtime information, system tools, system libraries, configuration files, and/or settings). A container may encapsulate application dependencies and ensure that the software executes predictably regardless of the underlying infrastructure. A container orchestration platform may abstract the underlying infrastructure for containerized applications by encapsulating application code and dependencies into container images, which may be portable and can execute consistently across different environments and/or infrastructure. Additionally, the container orchestration platform may manage the allocation of computing resources, networking resources, and/or storage resources for containers, thereby enabling developers to focus on application logic rather than infrastructure concerns.

A container orchestration platform may include one or more systems or pipelines for various use cases. For example, a container orchestration platform may include a machine learning operation system (e.g., a machine learning specific toolkit) that enables developers to generate pipelines and/or directed acyclic graphs (DAGs) for machine learning models. As an example, a machine learning operation system may be Kubeflow® of the Kubernetes® platform, however other machine learning operation system may be used in a similar manner as described herein. As used herein, “pipeline” may refer to one or more (e.g., a sequence of) machine learning tasks or steps organized into a workflow. A pipeline may be, or include, one or more DAGs (e.g., where each node in a DAG represents a task or a step in the workflow, and edges in the DAG represent the dependencies between tasks). The creation of pipelines via the machine learning operation system may enable developers to generate or create a machine learning algorithm in reusable and/or shareable components. The developers may use the pipelines and/or DAGs to perform training operations for a machine learning model via the machine learning operation system, which leverages the underlying infrastructure managed by the container orchestration platform.

However, because of the abstraction of the infrastructure away from the creation and/or management of the pipelines, it may be difficult to detect or identify when a change associated with the container orchestration platform will impact a pipeline. For example, changes associated with the container orchestration platform may include changing a version of the container orchestration platform, changing one or more configurations for an ingress controller of the container orchestration platform, and/or changing permissions or security information for the container orchestration platform (e.g., role-based access control permissions), among other examples. These changes may cause certain pipelines to not execute properly and/or to not function as expected. However, because of the abstraction of the infrastructure away from the creation and/or management of the pipelines, it may be difficult to detect or identify which pipelines will be impacted by a given change associated with the container orchestration platform.

Therefore, testing of the functionality of the machine learning operation system and/or the container orchestration platform for one or more pipelines may be performed when updates or changes are made for the machine learning operation system and/or the container orchestration platform. However, an entity or system may include many pipelines for various technologies and/or machine learning models. As a result, testing each platform every time a change is made to the underlying configuration of the machine learning operation system and/or the container orchestration platform may consume significant time, processing resources, computing resources, memory resources, and/or network resources associated with performing the large quantity of tests. However, not performing testing for one or more pipelines may result in a change to the underlying configuration of the machine learning operation system and/or the container orchestration platform, which may result in unintended and/or improper execution of the one or more pipelines via the machine learning operation system and/or the container orchestration platform. This may consume processing resources, computing resources, memory resources, and/or network resources associated with executing the one or more pipelines that do not execute or perform as properly and/or as expected.

Some implementations described herein enable automated container orchestration platform testing. For example, a testing device may perform testing for one or more pipelines using one or more training notebooks. A training notebook may be an interactive computational document that includes executable code and plain-text-formatted information for training and/or demonstrating how to build, code, and/or otherwise create a given type of pipeline. A training notebook may also be referred to as a demo notebook. For example, a training notebook may be a computational document that includes live code (e.g., executable code that can be executed via an application that provides the training notebook), equations, visualizations, and/or text. In some examples, a training notebook may be a Jupyter® notebook, an R Markdown® notebook, a Mathematica® notebook, an Emacs org-mode® notebook, or another type of computational notebook. A training notebook may include training information or demonstration information for a type of pipeline. The testing device may use information included in the training notebook to perform testing for the type of pipeline.

For example, the testing device may obtain, via a notebook repository, one or more training notebooks that are associated with respective pipeline types of the container orchestration platform. The testing device may extract, from the one or more training notebooks, one or more executable code elements, to obtain one or more sets of executable code for respective training notebooks of the one or more training notebooks. In some implementations, the testing device may insert testing information into respective sets of executable code of the one or more sets of executable code to generate one or more test pipelines. The testing device may perform, via a machine learning operation system of the container orchestration platform, one or more cluster tests using respective test pipelines from the one or more test pipelines. The testing device may provide, for display, result information indicating results of the one or more cluster tests.

As a result, the testing device may perform testing for the machine learning operation system and/or the container orchestration platform, where the results of the testing are applicable for multiple pipelines without having to test each of the multiple pipelines. For example, by generating a testing pipeline using a training notebook that is associated with a type of pipeline, the testing device may perform testing that is applicable to all pipelines associated with the type of pipeline. This may conserve time, processing resources, computing resources, memory resources, and/or network resources that would have otherwise been associated with performing tests for each individual pipeline associated with the type of pipeline. Additionally, this may improve a likelihood that a change associated with the machine learning operation system and/or the container orchestration platform for a pipeline can be identified prior to the change being implemented for a deployment of the pipeline (e.g., because the testing described herein may enable the testing device to identify issues or problems caused by the change). This may conserve processing resources, computing resources, memory resources, and/or network resources that would have otherwise been associated with executing the one or more pipelines that do not execute or perform properly and/or as expected because of the change. Additionally, by extracting the executable code elements from a training notebook, the testing device may reliably and/or consistently create testing pipelines that accurately reflect the format and/or structure of pipelines that are associated with the type of pipeline illustrated and/or demonstrated by the training notebook. This improves the reliability and/or the accuracy of the testing performed by the testing device.

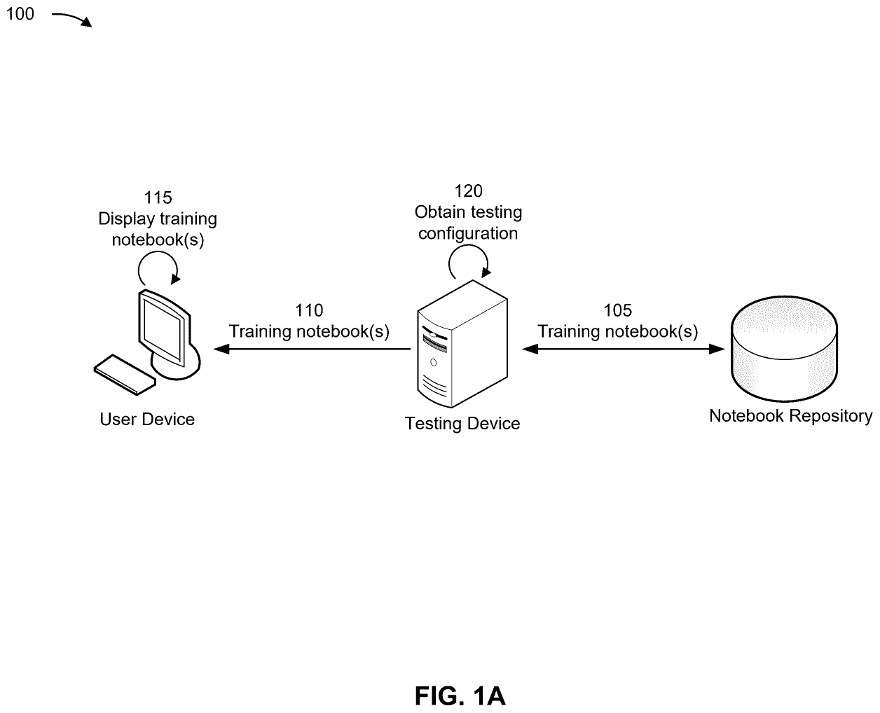

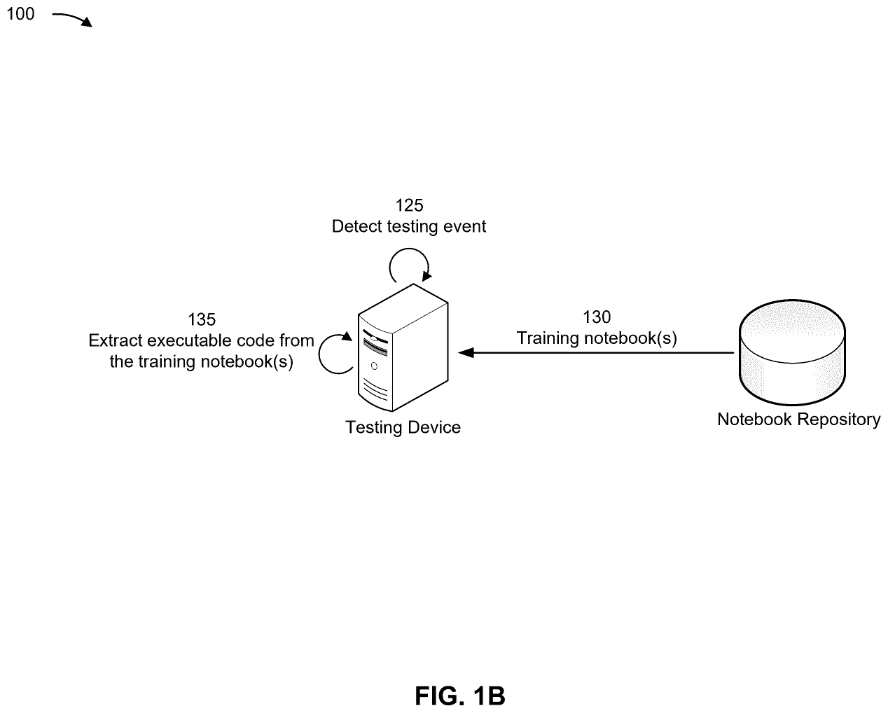

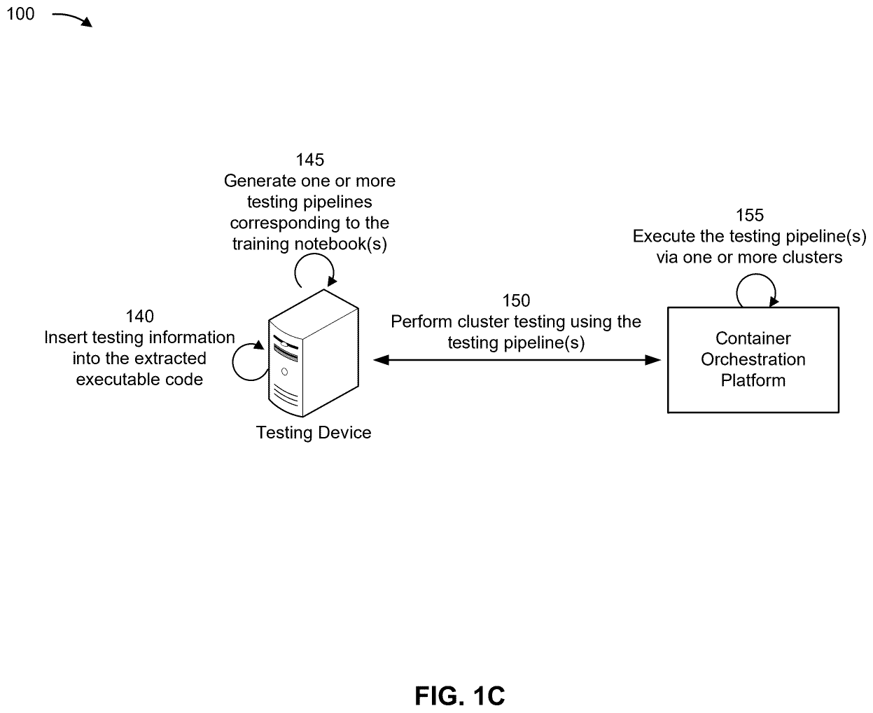

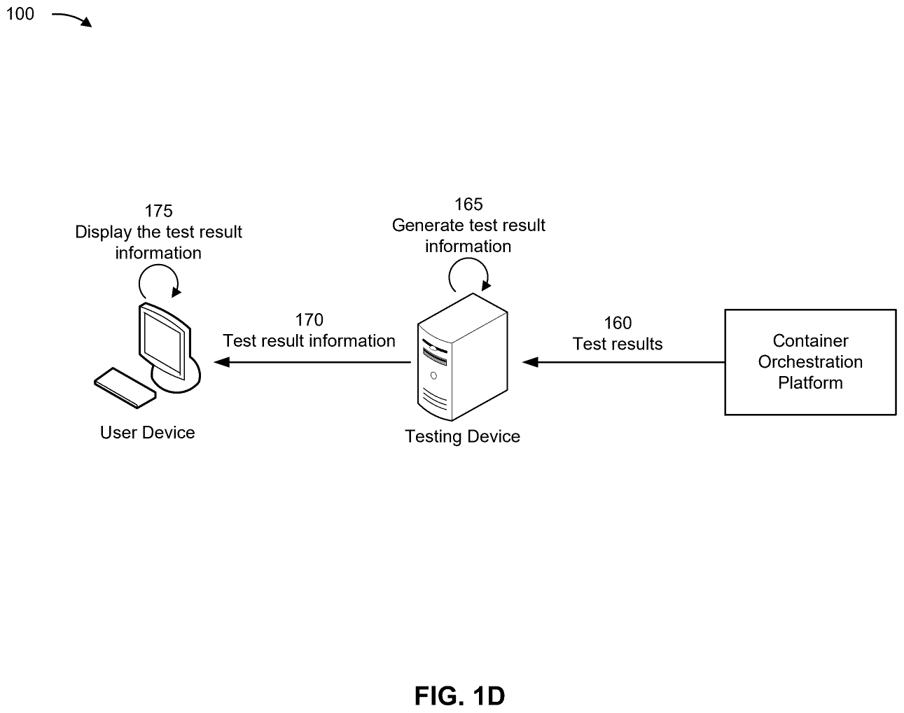

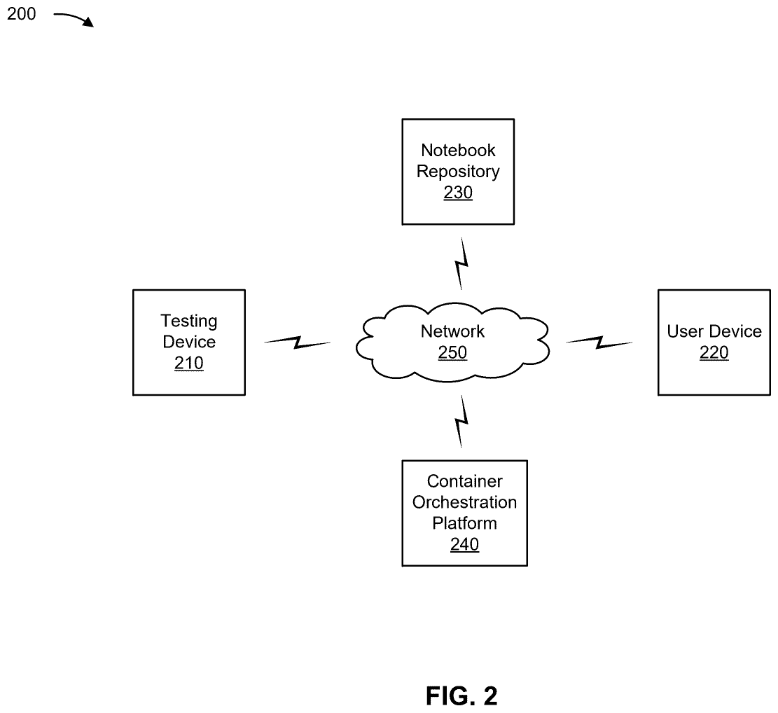

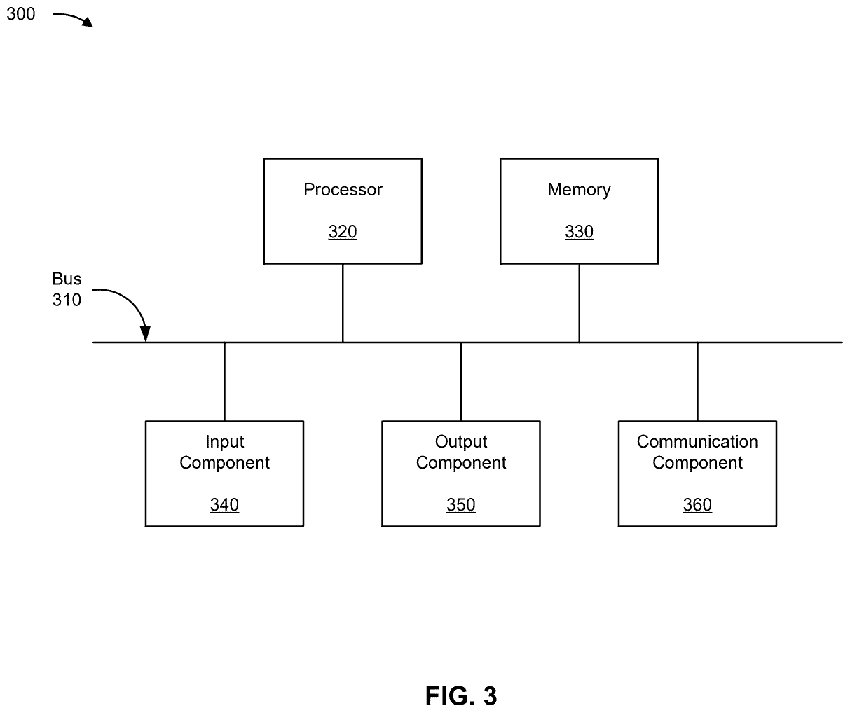

FIGS. 1A-1D are diagrams of an example 100 associated with automated container orchestration platform testing. As shown in FIGS. 1A-1D, example 100 includes a testing device, a user device, a notebook repository, and a container orchestration platform. These devices are described in more detail in connection with FIGS. 2 and 3.

As shown in FIG. 1A, and by reference number 105, the testing device may obtain one or more training notebooks for pipelines associated with a container orchestration platform. For example, the testing device may obtain the one or more training notebooks via the notebook repository. It should be understood that the notebook repository may store additional information or data other than training notebooks. For example, the notebook repository may be any repository that includes the one or more training notebooks (e.g., rather than a repository that only stores training notebooks). In some aspects, the testing device may obtain the one or more training notebooks from another device (e.g., the user device or another device, such as a server device of a platform that provides and/or otherwise manages the training notebooks). “Notebook” and “document” may be used interchangeably herein in the context of training notebooks and/or computations notebooks.

The one or more training notebooks may be computational documents or computational notebooks that provide an environment in which a user (e.g., a developer) can write plain-text information (e.g., prose) along with embedded code that is executable. For example, a training notebook may include executable code (e.g., embedded in the training notebook) and plain-text-formatted information. A training notebook may be an interactive computational document in that a user may write and execute code via an environment (e.g., an application) provided by the training notebook.

A training notebook may be associated with a type of pipeline. For example, the type of pipeline may be associated with a category, end goal, use case, and/or machine learning model, among other examples, associated with a pipeline. For example, a training notebook may provide training information and/or demonstration information to guide developers on how to code, build, construct, and/or otherwise create a pipeline for a given type of pipeline. A developer may use a training notebook as a guide or framework for creating a pipeline that is tailored to a specific scenario or information.

For example, as shown by reference number 110, the user device may receive or obtain one or more training notebooks. In some implementations, the testing device (or another device) may transmit, and the user device may receive, the one or more training notebooks. In some other implementations, the user device may obtain the one or more training notebooks from the notebook repository or from a platform that manages and/or provides the training notebooks. For example, a user of the user device may provide an input that causes the user device to request and/or obtain the one or more training notebooks.

As shown by reference number 115, the user device may display the one or more training notebooks. For example, the user device may display a web page or application in which the one or more training notebooks can be viewed and/or interacted with (e.g., in which code included in the one or more training notebooks can be executed). This enables the user (e.g., a developer) to view and/or interact with a guide or framework for creating pipelines for a given type of pipeline. In some implementations, the user device may obtain one or more pipelines. For example, the user may use the user device to create or generate the one or more pipelines (e.g., that follow a framework or guidelines indicated by the one or more training notebooks). In some implementations, the user device may transmit, and the testing device may receive, the one or more pipelines. In some implementations, the one or more pipelines may be stored in a repository (not shown in FIG. 1A) for execution via the container orchestration platform.

As shown by reference number 120, the testing device may obtain a testing configuration. The testing configuration may be associated with testing pipelines via the container orchestration platform. In some implementations, the testing device may obtain configuration information (e.g., the testing configuration) that indicates the notebook repository and testing information. For example, the testing configuration may indicate a location (e.g., a storage location, such as the notebook repository) via which the testing device can access the one or more training notebooks (e.g., the most up-to-date version of the training notebooks).

The testing information may be configurable information to be used by the testing device to generate testing pipelines using respective testing notebooks. The testing information may be, or may include, information to be added to extracted information (e.g., extracted from a training notebook) to generate a testing pipeline, as described in more detail elsewhere herein. For example, the testing information may include one or more arguments, one or more configurable code elements, and/or other testing information.

An argument may be a value that is passed to a function or method when called via executed code. An argument may include a variable, a literal value, and/or an expression, among other examples. An argument may include a positional argument, a keyword argument, a default argument, and/or a variable-length argument, among other examples. For example, an argument may be input data for a function to perform a task (e.g., an argument may be a parameter for which a value is determined at the time of function invocation). For example, the one or more arguments indicated by the testing information may include variables or parameters to be used by the container orchestration platform as part of a testing operation performed by the testing device. For example, the one or more arguments may include parameters or inputs that are used as part of the testing operation (e.g., but may not otherwise be relevant to the training information or demonstration information included in a training notebook).

The one or more configurable code elements may be executable code used to replace placeholder elements that may be included in the executable code that is included in a training notebook. For example, executable code included in a training notebook may include one or more placeholder elements that are designed or configured to be replaced or filled in by a developer (e.g., depending on the scenario, information, and/or use case being addressed by the developer). However, the executable code that includes a placeholder element may not execute properly because the placeholder element may not be executable and/or may not provide information that is usable by the container orchestration platform. Therefore, the testing information may include one or more configurable code elements that correspond to respective placeholder elements. The one or more configurable code elements may be executable elements that provide generic and/or template information for a field or parameter in which a given placeholder element is included.

The testing information may include a mapping or association between configurable code elements and placeholder elements. For example, the testing information may configure the testing device to detect placeholder elements in executable code extracted from a testing notebook. The testing information may enable the testing device to identify a configurable code element to be inserted by the testing device into the executable code extracted from the testing notebook to replace the placeholder element. This may increase the likelihood that a testing pipeline generated by the testing device, as described in more detail elsewhere herein, is executable by the container orchestration platform (e.g., to enable the testing operation to be accurately and/or successfully performed).

In some implementations, the testing configuration may indicate one or more testing events. A testing event may be an event that triggers or causes the testing device to perform a testing operation. For example, upon an occurrence of a testing event, the testing device may perform one or more cluster tests via the container orchestration platform, as described in more detail elsewhere herein. In some implementations, a testing event may be a defined or configured date and/or time. Additionally, or alternatively, a testing event may be a periodic event that occurs every N periods (e.g., every N hours, every N days, every N weeks, every N months). For example, the testing event may be configured via a cron schedule or a cron job. Additionally, or alternatively, a testing event may include an update or a change associated with the container orchestration platform. For example, a testing event may include a configuration of the container orchestration platform changing, a version of the container orchestration platform changing, a setting of the container orchestration platform changing, a permission or security parameter of the container orchestration platform changing, and/or another change associated with the container orchestration platform. For example, if the testing device detects that a change (e.g., configured or indicated by a testing event) has occurred, then the testing device may perform one or more cluster tests using one or more testing pipelines, as described in more detail elsewhere herein.

As shown in FIG. 1B, and by reference number 125, the testing device may detect a testing event. For example, the testing device may detect an occurrence of a testing event. As an example, the testing device may detect the testing event based on a current date and/or time (e.g., a testing event may schedule testing to be performed at the current date and/or time). Additionally, or alternatively, the testing device may detect that a change associated with the container orchestration platform has occurred. For example, the testing device may receive an indication of the change (e.g., from the container orchestration platform or from another device). Additionally, or alternatively, the testing device may analyze information (e.g., a configuration) of the container orchestration platform to detect or identify the change. For example, the change may include one or more changes described elsewhere herein.

As shown by reference number 130, the testing device may obtain one or more training notebooks. The testing device may obtain, via the notebook repository, the one or more training notebooks. For example, the testing device may obtain the one or more training notebooks based on an occurrence of the testing event. This may improve the likelihood that the obtained training notebooks are up-to-date and include information being used to develop pipelines for the container orchestration platform.

In some implementations, the testing device may obtain all training notebooks stored in the notebook repository. In some implementations, the testing device may obtain training notebooks that include an indicator or other information indicating that the training notebooks are to be used for testing (e.g., the training notebooks may include a flag or other indicator to indicate that the training notebooks are to be used for testing). In some implementations, the one or more training notebooks obtained by the testing device may be based on the testing event. For example, the testing device may obtain different training notebooks for different training events. In some implementations, the testing configuration may indicate which training notebooks are to be used to generate testing pipelines for certain testing events. The testing device may obtain the one or more training notebooks that are indicated (e.g., via the testing configuration) as being associated with the testing event that has occurred and/or is detected.

As shown by reference number 135, the testing device, for each training notebook, may extract executable code. For example, the testing device may extract, from the one or more training notebooks, one or more executable code elements, to obtain one or more sets of executable code for respective training notebooks of the one or more training notebooks. For example, the testing device may parse or analyze the one or more training notebooks to identify executable code elements. “Executable code element” may refer to a portion of a training notebook that includes executable code (e.g., executable code embedded in the training notebook). In some implementations, “executable code element” may refer to a code cell included in the training notebooks.

For example, the training notebooks may include cells for inputting or interacting with different types of information. As an example, the training notebooks may include code cells and markdown cells. A code cell may be designated for writing and executing code (e.g., content in a code cell may be interpreted as executable code by a kernel of the training notebook). A markdown cell may be designated for writing plain text (e.g., that is formatted using markdown syntax). Content in a markdown cell may be displayed as formatted text when the markdown cell is rendered (e.g., rather than being executed as code). For example, when a code cell is rendered, the content in the code cell may be executed as executable code. Therefore, the testing device may extract the executable code elements by identifying one or more code cells in the training notebook(s) and extracting content from the one or more code cells.

Additionally, or alternatively, the testing device may extract the one or more executable code elements by removing, from the one or more training notebooks, any information that is presented via a plain-text formatting syntax. For example, the testing device may identify one or more markdown cells in the training notebook(s). The testing device may remove content included in the one or more markdown cells. Additionally, the testing device may remove any visual content (e.g., graphs or other visual data) included in the one or more training notebooks.

As shown in FIG. 1C, and by reference number 140, the testing device may insert testing information into the extracted executable code. For example, the testing device may insert relevant testing information (e.g., from the configuration information) into the executable code extracted from a training notebook. For example, the testing device may insert testing information into respective sets of executable code of the one or more sets of executable code to generate one or more test pipelines, as described elsewhere herein.

For example, the testing device may detect, in a set of executable code from the one or more sets of executable code, a placeholder element. As an example, the testing device may detect a placeholder element based on one or more delimiters, such as brackets, parentheses, and/or another character or delimiter. For example, a placeholder element may be identified by being included between brackets or other delimiters (e.g., a placeholder element may be included in the executable code as “[placeholder element]”). As another example, the testing device may identify a placeholder element based on a field in which the placeholder element is included. For example, the testing device may identify a field type of a field in which the placeholder element is included. The testing device may determine a configurable code element based on the field type. For example, the testing configuration may indicate that the configurable code element is to be inserted for placeholder elements included in the field type.

The testing device may replace the placeholder element with a configurable code element of the one or more configurable code elements indicated via the testing configuration. In some implementations, the configurable code element may correspond to the placeholder element. For example, the configurable code element may correspond to the placeholder element in that a mapping or association (e.g., indicated or included in the testing configuration) may indicate that the placeholder element is to be replaced by the configurable code element.

Additionally, or alternatively, the testing device may insert one or more arguments into the executable code extracted from a training notebook. For example, the testing information may indicate one or more arguments to be inserted into the extracted executable code. In some examples, the testing configuration may indicate a location within the extracted executable code where the one or more arguments are to be inserted. For example, the testing configuration may indicate that the one or more arguments are to be inserted at a start or an end of the extracted executable code. The testing device may insert the one or more arguments into the location indicated by the testing configuration.

As shown by reference number 145, the testing device may generate one or more testing pipelines corresponding to the one or more training notebooks. For example, the one or more testing pipelines may be based on respective training notebooks of the one or more training notebooks. As an example, for a given training notebook, the testing device may extract executable code and insert testing information (e.g., as described in more detail elsewhere herein) to generate a testing package for the training notebook. The testing device may format the training notebook in a format associated with the container orchestration platform to generate a testing pipeline corresponding to the training notebook. For example, the format may be a format that is executable by the container orchestration platform. For example, a testing pipeline may represent or indicate a workflow for a machine learning operation system that is illustrated or demonstrated via a given training notebook. The testing device may generate other testing pipelines for other training notebooks in a similar manner.

As shown by reference number 150, the testing device may perform cluster testing using the one or more testing pipelines. The testing device may perform the cluster testing via the machine learning operation system of the container orchestration platform. For example, the testing device may cause one or more tests to be performed for one or more clusters of the container orchestration platform using the one or more testing pipelines. As shown by reference number 155, the container orchestration platform may execute the one or more testing pipelines via one or more clusters.

The cluster testing may include one or more tests. The one or more tests may be configurable or may be indicated (or performed) by the machine learning operation system of the container orchestration platform. The one or more tests may include one or more node health checks (e.g., to check system resources (processing resources, memory resources, or disk space), network connectivity, and/or other resources of infrastructure provided via the container orchestration platform), one or more scaling tests (e.g., to test a cluster's availability to scale by adding or removing nodes from the cluster), one or more network tests, one or more failure recovery tests, one or more resource management tests, one or more fault injection tests, one or more security tests, and/or one or more performance tests, among other examples. The testing may be performed by executing the one or more testing pipelines via the container orchestration platform.

As shown in FIG. 1D, and by reference number 160, the container orchestration platform may provide, and the testing device may receive, test results. The test results may indicate information obtained from performing the clustering testing. For example, the test result may include one or more performance metrics, such as a processing utilization, a memory utilization, a disk space usage, a latency, a packet loss rate, a node provisioning time, a network latency, a throughput, a recovery time, and/or one or more failures, among other examples.

As shown by reference number 165, the testing device may generate test result information. For example, the testing device may generate the test result information based on, or using, the test results provided by the container orchestration platform. For example, the testing device may analyze the test results to generate the test result information. For example, the testing device may determine whether a test has been passed or failed by comparing one or more metrics indicated by the test results to one or more thresholds. The test result information may include an indication of whether a given test has been passed or failed based on the whether the one or more metrics satisfy the one or more thresholds.

Additionally, the testing device may associate test results to a given test platform (and/or type of pipeline). For example, the testing device may identify which testing pipeline was used to generate certain test results. The testing device may generate test result information indicating that the test results are associated with a type of pipeline that is associated with the testing pipeline (e.g., whether the type of pipeline is based on the training notebook used to generate the testing pipeline).

As shown by reference number 170, the testing device may transmit, and the user device may receive, the test result information. For example, the testing device may transmit display information that causes the user device to display the test result information. As shown by reference number 175, the user device may display the test result information. For example, the user device may display the test result information via a user interface.

Additionally, or alternatively, the testing device may perform one or more actions based on the test result information. For example, the testing device may control traffic flow for one or more pipelines based on the test result information. For example, if the test result information indicates that one or more tests for a testing pipeline have failed, then the testing device may restrict or stop traffic flow for one or more pipelines that are the type of pipeline associated with the testing pipeline. As another example, the testing device may cause a change associated with the container orchestration platform to not be deployed for one or more pipelines. For example, if the test result information indicates that one or more tests for a testing pipeline have been failed, then the testing device may transmit an indication that one or more changes to the container orchestration platform should not be deployed (e.g., because the one or more changes may impact deployed pipelines as indicated by the failure of the one or more tests).

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a testing device 210, a user device 220, a notebook repository 230, a container orchestration platform 240, and a network 250. Devices of environment 200 may interconnect via wired connections, wireless connections, or a combination of wired and wireless connections.

The testing device 210 may include one or more devices capable of receiving, generating, storing, processing, providing, and/or routing information associated with automated container orchestration platform testing, as described elsewhere herein. The testing device 210 may include a communication device and/or a computing device. For example, the testing device 210 may include a server, such as an application server, a client server, a web server, a database server, a host server, a proxy server, a virtual server (e.g., executing on computing hardware), or a server in a cloud computing system. In some implementations, the testing device 210 may include computing hardware used in a cloud computing environment.

The user device 220 may include one or more devices capable of receiving, generating, storing, processing, and/or providing information associated with automated container orchestration platform testing, as described elsewhere herein. The user device 220 may include a communication device and/or a computing device. For example, the user device 220 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The notebook repository 230 may include one or more devices capable of receiving, generating, storing, processing, and/or providing information associated with automated container orchestration platform testing, as described elsewhere herein. The notebook repository 230 may include a communication device and/or a computing device. For example, the notebook repository 230 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the notebook repository 230 may store training notebooks, as described elsewhere herein.

The container orchestration platform 240 may include one or more devices capable of receiving, generating, storing, processing, providing, and/or routing information associated with automated container orchestration platform testing, as described elsewhere herein. The container orchestration platform 240 may include a communication device and/or a computing device. For example, the container orchestration platform 240 may include a server, such as an application server, a client server, a web server, a database server, a host server, a proxy server, a virtual server (e.g., executing on computing hardware), or a server in a cloud computing system. In some implementations, the container orchestration platform 240 may include computing hardware used in a cloud computing environment.

The network 250 may include one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with automated container orchestration platform testing. The device 300 may correspond to the testing device 210, the user device 220, the notebook repository 230, and/or the container orchestration platform 240. In some implementations, the testing device 210, the user device 220, the notebook repository 230, and/or the container orchestration platform 240 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

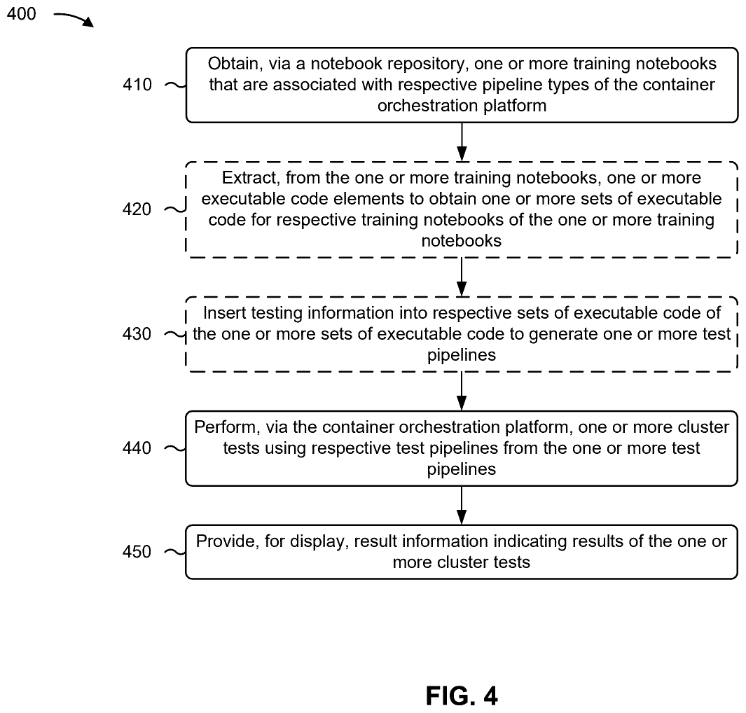

FIG. 4 is a flowchart of an example process 400 associated with automated container orchestration platform testing. In some implementations, one or more process blocks of FIG. 4 may be performed by the testing device 210. In some implementations, one or more process blocks of FIG. 4 may be performed by another device or a group of devices separate from or including the testing device 210, such as the user device 220, the notebook repository 230, and/or the container orchestration platform 240. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining, via a notebook repository, one or more training notebooks that are associated with respective pipeline types of the container orchestration platform (block 410). For example, the testing device 210 (e.g., using processor 320 and/or memory 330) may obtain, via a notebook repository, one or more training notebooks that are associated with respective pipeline types of the container orchestration platform, as described above in connection with reference number 130 of FIG. 1B. As an example, the testing device 210 may obtain the one or more training notebooks to generate testing pipelines for the respective pipeline types.

As further shown in FIG. 4, process 400 may optionally include extracting, from the one or more training notebooks, one or more executable code elements, to obtain one or more sets of executable code for respective training notebooks of the one or more training notebooks (block 420). For example, the testing device 210 (e.g., using processor 320 and/or memory 330) may extract, from the one or more training notebooks, one or more executable code elements, to obtain one or more sets of executable code for respective training notebooks of the one or more training notebooks, as described above in connection with reference number 135 of FIG. 1B. As an example, the testing device 210 may detect executable code in the one or more training notebooks (e.g., in code cells of the training notebook(s)). The testing device 210 may extract the detected executable code.

As further shown in FIG. 4, process 400 may optionally include inserting testing information into respective sets of executable code of the one or more sets of executable code to generate one or more test pipelines (block 430). For example, the testing device 210 (e.g., using processor 320 and/or memory 330) may insert testing information into respective sets of executable code of the one or more sets of executable code to generate one or more test pipelines, as described above in connection with reference number 140 of FIG. 1C. As an example, the testing information may include one or more arguments and/or one or more configurable code elements (e.g., that replace respective placeholder elements in the extracted executable code).

As further shown in FIG. 4, process 400 may include performing, via the container orchestration platform, one or more cluster tests using respective test pipelines from the one or more test pipelines (block 440). For example, the testing device 210 (e.g., using processor 320 and/or memory 330) may perform, via the container orchestration platform, one or more cluster tests using respective test pipelines from the one or more test pipelines, as described above in connection with reference number 150 of FIG. 1C. As an example, the test pipelines may include the respective test packages. A test package may include executable code (e.g., extracted from a given training notebook with added testing information). The one or more cluster tests may be performed by causing the one or more testing pipelines to be executed via the container orchestration platform.

As further shown in FIG. 4, process 400 may include providing, for display, result information indicating results of the one or more cluster tests (block 450). For example, the testing device 210 (e.g., using processor 320 and/or memory 330) may provide, for display, result information indicating results of the one or more cluster tests, as described above in connection with reference number 170 of FIG. 1D. As an example, the testing device 210 may cause the result information (e.g., test result information) to be displayed by another device, such as the user device 220.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for automated cluster testing for a container orchestration platform, the system comprising:
one or more memories; and
one or more processors, communicatively coupled to the one or more memories, configured to:
obtain, via a notebook repository, one or more training notebooks that are associated with respective pipeline types of the container orchestration platform,
wherein the one or more training notebooks are interactive computational documents that include executable code and plain-text-formatted information;
extract, from the one or more training notebooks, one or more executable code elements, to obtain one or more sets of executable code for respective training notebooks of the one or more training notebooks;
insert testing information into respective sets of executable code of the one or more sets of executable code to generate one or more test pipelines;
perform, via a machine learning operation system of the container orchestration platform, one or more cluster tests using respective test pipelines from the one or more test pipelines; and
provide, for display, result information indicating results of the one or more cluster tests.

2. The system of claim 1, wherein the one or more processors are further configured to:
provide, for display via a user device, at least one training notebook of the one or more training notebooks.

3. The system of claim 1, wherein the testing information includes at least one of:
one or more arguments, or
one or more configurable code elements.

4. The system of claim 3, wherein the one or more processors, to insert the testing information, are configured to:
detect, in a set of executable code from the one or more sets of executable code, a placeholder element; and
replace the placeholder element with a configurable code element of the one or more configurable code elements, wherein the configurable code element corresponds to the placeholder element.

5. The system of claim 1, wherein the one or more cluster tests are associated with a testing event, and wherein the one or more processors, to obtain the one or more training notebooks, are configured to:
obtain the one or more training notebooks based on an occurrence of the testing event.

6. The system of claim 1, wherein the one or more processors are further configured to:
obtain configuration information indicating the notebook repository and the testing information.

7. The system of claim 1, wherein the one or more test pipelines indicate respective workflows for the machine learning operation system, and
wherein the one or more processors, to perform the one or more cluster tests, are configured to:
execute, via the machine learning operation system, the respective workflows,
wherein the result information indicates whether the respective workflows were successfully executed.

8. A method for cluster testing for a container orchestration platform, comprising:
obtaining, by a device and via a notebook repository, one or more training notebooks that are associated with respective pipeline types of the container orchestration platform;
extracting, by the device and from the one or more training notebooks, one or more executable code elements, to obtain one or more sets of executable code for respective training notebooks of the one or more training notebooks;
inserting, by the device, testing information into respective sets of executable code of the one or more sets of executable code to generate one or more test pipelines;
performing, by the device and via the container orchestration platform, one or more cluster tests using respective test pipelines from the one or more test pipelines; and
providing, by the device and for display, result information indicating results of the one or more cluster tests.

9. The method of claim 8, wherein the one or more training notebooks are interactive computational documents that include executable code and plain-text-formatted information, and wherein extracting the one or more executable code elements comprises:
removing, from the one or more training notebooks, any information that is presented via a plain-text formatting syntax.

10. The method of claim 8, wherein the one or more training notebooks include training information for the respective pipeline types associated with the container orchestration platform.

11. The method of claim 8, further comprising:
providing, for display via a user device, at least one training notebook of the one or more training notebooks.

12. The method of claim 8, wherein the testing information includes one or more configurable code elements.

13. The method of claim 12, wherein inserting the testing information comprises:
detecting, in a set of executable code from the one or more sets of executable code, a placeholder element;
obtaining a configurable code element from the one or more configurable code elements,
wherein the configurable code element is associated with a field type associated with the placeholder element; and
replacing the placeholder element with the configurable code element.

14. The method of claim 8, wherein the one or more cluster tests are associated with a testing event, and wherein obtaining the one or more training notebooks comprises:
obtaining the one or more training notebooks based on an occurrence of the testing event.

15. The method of claim 8, wherein the one or more test pipelines indicate respective workflows for a machine learning operation system of the container orchestration platform, and
wherein performing the one or more cluster tests comprises:
executing, via the machine learning operation system, the respective workflows,
wherein the result information indicates whether the respective workflows were successfully executed.

16. A non-transitory computer-readable medium storing a set of instructions, the set of instructions comprising:
one or more instructions that, when executed by one or more processors of a device, cause the device to:
provide, for display, one or more training notebooks that are associated with respective pipeline types of a container orchestration platform;
execute, via the container orchestration platform, one or more cluster tests using respective test pipelines from one or more test pipelines,
wherein the one or more test pipelines are generated via executable code included in the one or more training notebooks; and
provide, for display, result information indicating results of the one or more cluster tests.

17. The non-transitory computer-readable medium of claim 16, wherein the one or more instructions further cause the device to:
extract, from the one or more training notebooks, one or more executable code elements included in the executable code.

18. The non-transitory computer-readable medium of claim 17, wherein the one or more instructions further cause the device to:
insert testing information into one or more executable code elements to generate the one or more test pipelines.

19. The non-transitory computer-readable medium of claim 16, wherein the one or more instructions further cause the device to:
remove, from the one or more training notebooks, any information that uses a plain-text formatting syntax.

20. The non-transitory computer-readable medium of claim 16, wherein the one or more cluster tests are associated with a testing event, and wherein the one or more instructions further cause the device to:
obtain the one or more training notebooks based on an occurrence of the testing event.
